(19) United States
(12) Patent Application Publication
(10) Pub. No.: US 2022/0198676 A1
(43) Pub. Date: Jun. 23, 2022

(54) OVERLAPPED ELEMENT IDENTIFICATION WITHIN AN IMAGE

(71) Applicant: Hewlett-Packard Development Company, L.P., Spring, TX (US)

(72) Inventors: Ashly Lau, Singapore (SG); Sai Horng Soo, Singapore (SG); Ching Yong Chua, Singapore (SG); Wee Teck Woon, Singapore (SG)

(73) Assignee: Hewlett-Packard Development Company, L.P., Spring, TX (US)

(21) Appl. No.: 17/311,780

(22) PCT Filed: Sep. 11, 2019
(86) PCT No.: PCT/US2019/050521

§ 371 Date: Jun. 8, 2021

(51) Int. Cl. G06T 7/155; G06T 7/194; G06T 3/60; G06T 7/12

(52) U.S. Cl. CPC G06T 7/155; G06T 7/194; G06T 3/60; G06T 7/12; G06T 2207/30176; G06T 2207/20132; G06T 2207/20036; G06T 2207/10008; G06T 2207/20152

(57) ABSTRACT

In one example a computing device can include a processing resource and a non-transitory computer readable medium storing instructions executable by the processing resource to: identify when a first element overlaps a second element within a first image, identify an overlap location based on a shape search within the first image to identify an outline of the first element and the second element, and generate a second image that includes: the first element without the second element, and the second element with a cropped portion that corresponds to the overlap location.

### BACKGROUND

In some examples, documents can be stored by capturing the documents with a digital camera or other image capturing device. In some examples, the content of the documents can be extracted from the digital representation of the documents. For example, a document can be scanned to generate a digital image of the document and an extraction method can be utilized to extract the text or images from the digital image.

### BRIEF DESCRIPTION OF THE DRAWINGS

FIG. 1 is an example computing device for overlapped element identification consistent with the present disclosure.

FIG. 2 is an example memory resource for overlapped element identification consistent with the present disclosure.

FIG. 3 is an example system for overlapped element identification consistent with the present disclosure.

FIG. 4 is an example of images when convolving an image consistent with the present disclosure.

FIG. 5 is an example of images when determining borders of elements within an image consistent with the present disclosure.

FIG. 6 is an example of images when performing a shape search on an image consistent with the present disclosure.

### DETAILED DESCRIPTION

In some examples, an image can include a plurality of elements such as pictures, documents, receipts, and/or other types of elements that can be captured by an optical device such as an image capturing device. In some examples, the optical device can include, but is not limited to, a camera, a scanner, and/or other types of devices that can capture still images such as a picture. In some examples, a first element can overlap a second element within an image. For example, a first receipt can be positioned over a portion of a second receipt within the image. In this example, the portion of the second receipt can be covered by the first receipt and thus may not be viewable within the image.

In some examples, the elements within the image can be extracted to be utilized by other services. For example, the elements can be receipts that can be extracted by a financing service to track spending and identify locations of spending. In this example, the text and/or images printed on the receipt can be extracted and utilized by the financing service. In some examples, the overlapped elements within the image can make extraction of data associated with the elements more difficult. For example, the overlapping elements can be overlapping documents. In this example, the overlapping documents can be determined to be a single document which can cause errors for other services extracting the information from the overlapping documents.

The present disclosure relates to identifying and separating overlapping elements within an image. In this way, overlapping elements within an image can be separated and data associated with the overlapping elements can be separately extracted. In some examples, the devices, methods, memory resources, and/or systems described herein can be utilized to identify overlapping elements, identify the boundaries of the overlapping elements, perform a shape search to identify the overlapping portion, and/or crop the overlapping portion such that the overlapping elements can be separated.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

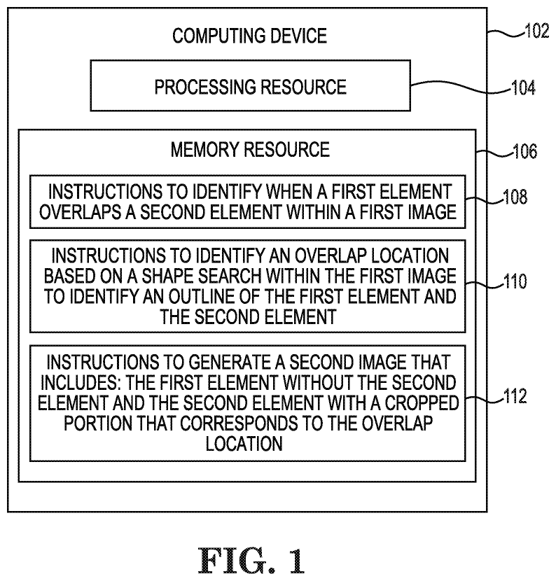

FIG. 1 is an example computing device 102 for overlapped element identification consistent with the present disclosure. In some examples, the computing device 102 can be part of a system for extracting text and/or images from elements within an image. For example, the computing device 102 can be part of a financial system for extracting location and payment information from a plurality of receipts positioned within an image. The examples described herein refer to receipts, but examples are not so limited. For example, other types of documents or elements within an image can separated when the documents or elements overlap within the image.

In some examples, the computing device 102 can include a processing resource 104 and/or a memory resource 106 storing instructions to perform particular functions. A processing resource 104, as used herein, can include a number of processing resources capable of executing instructions stored by a memory resource 106. The instructions (e.g., machine-readable instructions (MRI), computer-readable instructions (CRI), etc.) can include instructions stored on the memory resource 106 and executable by the processing resource 104 to perform or implement a particular function. The memory resource 106, as used herein, can include a number of memory components capable of storing non-transitory instructions that can be executed by the processing resource 104.

The memory resource 106 can be in communication with the processing resource 104 via a communication link (e.g., communication path). The communication link can be local or remote to an electronic device associated with the processing resource 104. The memory resource 106 includes instructions 108, 110, 112. The memory resource 106 can include more or fewer instructions than illustrated to perform the various functions described herein. In some examples, instructions (e.g., software, firmware, etc.) can be downloaded and stored in memory resource 106 (e.g., MRM) as well as a hard-wired program (e.g., logic), among other possibilities. In other examples, the computing device 102 can be hardware, such as an application-specific integrated circuit (ASIC), that can include instructions to perform particular functions.

The computing device 102 can include instructions 108 stored by the memory resource 106, that when executed by a processing resource 104 can identify when a first element overlaps a second element within a first image. In some examples, the first image can be a digitized still image (e.g., digital picture, digital scan, etc.) that includes a plurality of elements including the first element and the second element. In some examples, the plurality of elements can include a digitized still image of documents, pictures, and/or other objects that include boundaries.

In some examples, identifying that the first element overlaps the second element can include determining that a portion of the second element is covered by the first element. For example, the first element and the second element can be a first receipt and a second receipt respectively. In this example, the instructions 108 can identify that a portion of information associated with the second receipt is not identified. In this example, the first element and the second element can be flagged as possibly overlapping. In some examples, the flagged elements can be extracted or separated from the remaining plurality of elements. That is, the first element and the second element can be flagged and separated from the remaining plurality of elements for further analysis.

The computing device 102 can include instructions 110 stored by the memory resource 106, that when executed by a processing resource 104 can identify an overlap location based on a shape search within the first image to identify an outline of the first element and the second element. In some examples, the first image can be processed to further clarify the boundaries of the first element and the second element. The processing of the image is described further herein. For example, the computing device 102 can utilize a convolution filter to convolve the first image. In this example, the computing device 102 utilize the convolution image to generate a background and a foreground image. As used herein, a convolution filter can generate a grayscale image that can highlight lines within the image. The background and foreground image can be subtracted to perform a watershed process on the subtracted image to identify borders of the first element and the second element. In addition, the watershed image can be eroded through an erosion process to further highlight the borders of the first element and the second element. As used herein, the erosion filter can be utilized to identify pixels that are minimum priority pixels compared to adjacent pixels. The eroded image can be utilized to identify shapes of the first element and the second element through a shape search. As used herein, a shape search can include a process to identify geometric shapes (e.g., squares, rectangles, circles, polygons, etc.). In this way, the borders of the first element and the second element can be identified and the overlap portion can be identified as the portion where a border of the first element crosses the border of the second element.

The computing device 102 can include instructions 110 stored by the memory resource 106, that when executed by a processing resource 104 can generate a second image that includes: the first element without the second element and the second element with a cropped portion that corresponds to the overlap location. As described herein, data can be extracted from the first element and/or the second element to be utilized by a particular system. In these examples, the overlapped portion of the first element can be cropped to avoid extracted data from the first element being associated with the data of the second element. For example, the first element can be a first receipt and the second element can be a second receipt. In this example, the first receipt can cover a portion of the second receipt. If the overlap portion of the first receipt that covers the portion of the second receipt is not cropped, data printed on the overlap portion can be included with other extracted data associated with the second receipt.

In some examples, the first element can be separated from the second element such that the first element and the second element can be utilized separately by a system. In this way, the computing device 100 can generate a second image that includes the first element separated from the second element such that the overlapped portion is cropped from the second image. In this way, the system can individually extract data from the first element and the second element without potentially extracting data associated with the first element and including it with data extracted from the second element.

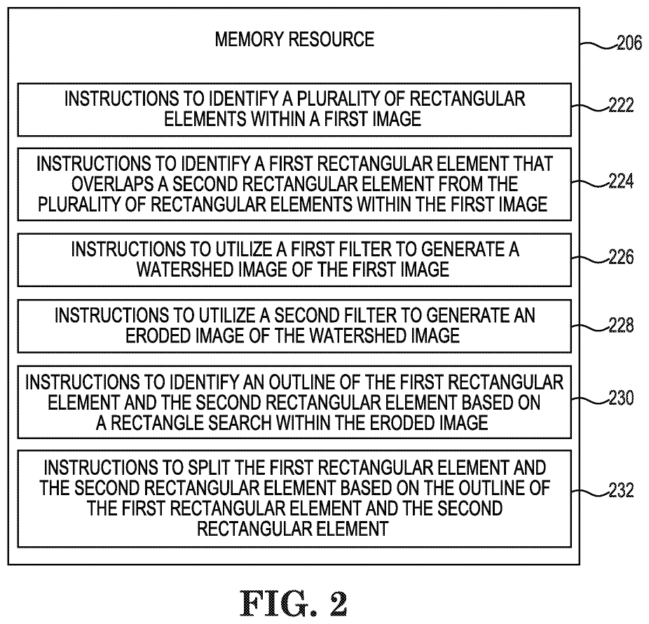

FIG. 2 is an example memory resource 206 for overlapped element identification consistent with the present disclosure. In some examples, the memory resource 206 can be part of a computing device. For example, the memory resource 206 can be part of a computing device 102 as referenced in FIG. 1.

The memory resource 206 can be in communication with a processing resource (e.g., processing resource 104 as illustrated in FIG. 1, etc.) via a communication link (e.g., communication path). The communication link can be local or remote to an electronic device associated with the processing resource. The memory resource 206 includes instructions 222, 224, 226, 228, 230, 232. The memory resource 206 can include more or fewer instructions than illustrated to perform the various functions described herein. In some examples, instructions (e.g., software, firmware, etc.) can be downloaded and stored in memory resource 206 (e.g., MRM) as well as a hard-wired program (e.g., logic), among other possibilities.

The memory resource 206 can include instructions 222, that when executed by a processing resource can identify a plurality of rectangular elements within a first image. In some examples, the memory resource 206 can include instructions to determine a shape of the plurality of elements. In these examples, the memory resource 206 can determine that the shape of the plurality of elements are substantially rectangular. In some examples, the instructions 222 can be executed in response to determining that the shape of the plurality of elements are substantially rectangular. As used herein, substantially rectangular can be more rectangular than non-rectangular. For example, substantially rectangular can be elements that include four sides. Rectangular elements are described herein, however examples are not so limited. For example, the elements can be other shapes that can be identified by the memory resource 206, such as circles, ovals, other polygonal shapes, non-polygonal shapes, or others.

The memory resource 206 can include instructions 224, that when executed by a processing resource can identify a first rectangular element that overlaps a second rectangular element from the plurality of rectangular elements within the first image. In some examples, the instructions 224 to identify overlapping elements from the plurality of elements can include instructions to identify an irregular shaped element from the plurality of elements. For example, the plurality of elements can be identified as rectangular elements and the instructions 224 can identify that the first rectangular element and the second rectangular element are overlapping when a combined shape of the first rectangular element and the second rectangular element is irregular or non-rectangular. In this way, the memory resource 206 can determine that an irregular shaped element corresponds to two or more elements overlapping. For example, an irregular shaped element can be a shape formed by a first rectangular element overlapping a portion of a second rectangular element.

The memory resource 206 can include instructions 226, that when executed by a processing resource can utilize a first filter to generate a watershed image of the first image. In some examples, the first filter can be a watershed filter or watershed process to generate a watershed image. In some examples, the first filter can be applied to a portion of the first image that includes the identified first rectangular element overlapping the second rectangular element. In some examples, the watershed process (e.g., Meyer's flooding process, etc.) can include identifying a priority level for each pixel within the image and/or portion of the image. In some examples, the priority level for the pixels can be based on a gradient magnitude of the corresponding pixel. As used herein, a gradient magnitude can include a rate of change in the intensity at the pixel. In these examples, the pixels with a relatively higher priority level can be the boundaries of the first rectangular element and the boundaries of the second rectangular element. Thus, the watershed process can be utilized to highlight the borders or boundaries of the first rectangular element and the boundaries of the second rectangular element.

The memory resource 206 can include instructions 228, that when executed by a processing resource can utilize a second filter to generate an eroded image of the watershed image. In some examples, the second filter can be an erosion filter or an erosion process that can be applied to the first image and/or applied to a portion of the first image that includes the first rectangular element and the second rectangular element. That is, the second filter can be applied to portions of the first image that include overlapping elements. In some examples, the second filter can be applied to the same portion that the first filter was applied in order to further highlight the borders of the first rectangular element and/or the second rectangular element.

In some examples, the erosion filter or erosion process can be a grayscale erosion filter. Examples of a grayscale erosion filter are described herein, however, the disclosure is not limited to these examples. For example, the erosion filter can be a binary erosion filter or other type of erosion filter. In some examples, the erosion filter can be utilized to identify pixels that are minimum priority pixels compared to adjacent pixels. In this way, lower priority level pixels can be removed from the image to further highlight the boundaries and/or borders of the first rectangular element and second rectangular element.

The memory resource 206 can include instructions 230, that when executed by a processing resource can identify an outline of the first rectangular element and the second rectangular element based on a rectangle search within the eroded image. In some examples, the rectangle search can include instructions that search for rectangular shaped elements within the first image. In some examples, the rectangle search can be performed on the eroded image to simply the rectangle search to identify the borders or outline of the first rectangular element and the borders or outline of the second rectangular element.

In some examples, the rectangle search can be utilized to identify an overlap portion where the first rectangular element covers the second rectangular element. For example, the rectangle search can be utilized to more precisely identify the overlap portion since the border or outline of the first rectangular element can identify a portion of the first rectangular element that is covering a portion of the second rectangular element. As described further herein, having a more precise overlap portion can provide a more precise crop of the first rectangular element from the second rectangular element when separating the first rectangular element from the second rectangular element.

The memory resource 206 can include instructions 232, that when executed by a processing resource can split the first rectangular element and the second rectangular element based on the outline of the first rectangular element and the second rectangular element. As described herein, the first rectangular element can be separate and distinct from the second rectangular element. For example, the first rectangular element can be a first document with a first set of data and the second rectangular element can be a second document with a second set of data. In some examples, the first rectangular element can be split from the second rectangular element such that the first set of data can be separated from the second set of data during a data extraction.

In some examples, splitting the first rectangular element from the second rectangular element can include separating the first rectangular element from the second rectangular element such that there is a space between the first rectangular element and the second rectangular element. In these examples, the space between the first rectangular element and the second rectangular element can allow a system or service to individually extract a first set of data from the first rectangular element and a second set of data from the second rectangular element.

In some examples, the split first rectangular element may include the full element. For example, the first rectangular element may not be covered by another element within the image and the full image of the first rectangular element can be available. In some examples, the split second rectangular element can include a portion that was covered by the first rectangular element. In these examples, the covered portion or overlap portion of the second rectangular element can be cropped or removed from the second rectangular element. In this way, data that is positioned on the first rectangular element that is covering the overlap portion is removed prior to extracting data from the second rectangular element.

In some examples, splitting the first rectangular element and the second rectangular element can include generating a first image that does not include the second rectangular element and generating a second image that does not include the first rectangular element and includes the second rectangular image with a cropped portion that corresponds to the overlap portion. In this way, the first rectangular element and the second rectangular element can be utilized separately without incorporating data from the first rectangular element into the data associated with the second rectangular element.

In some examples, the memory resource 206 can include instructions to convert a second image that includes only the first rectangular element and a third image that includes only the second rectangular element into a same format as the first image. For example, the first image can include a color image of the first rectangular element and the second rectangular element. In this example, the filters applied to the first image can alter the image as described herein (e.g., converting the image to grayscale, applying a filter, etc.). In this example, the separated second rectangular element and second rectangular element can be converted back to a color image.

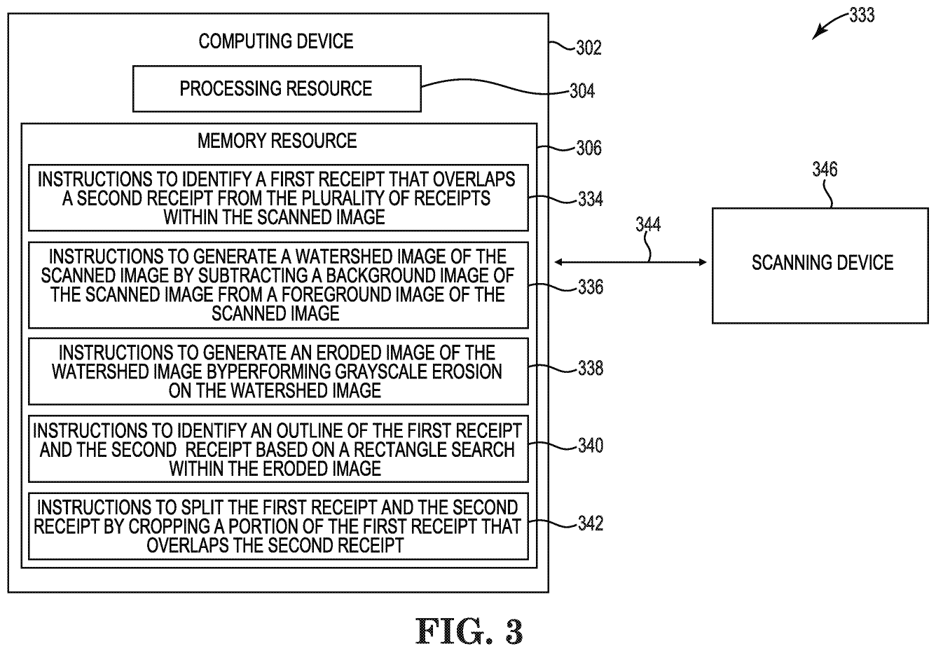

FIG. 3 is an example system 333 for overlapped element identification consistent with the present disclosure. In some examples, the system 333 can include a scanning device 346. In some examples, the scanning device 346 can include a device that can capture a still image or video. For example, the scanning device 346 can be an image scanner, camera, and/or other type of electronic device that can capture a digital image. In some examples, the scanner device 346 can utilize a patterned background to capture an image of a plurality of elements. In some examples, the patterned background can be utilized to more precisely identify the borders or outline of the elements. In one example, the patterned background can be a striped pattern where the stripes are separated by a particular distance (e.g., four pixels, etc.).

In some examples, the system 333 can include a computing device 302. In some examples, the computing device 302 can be the same or similar device as computing device 102 as referenced in FIG. 1. For example, the computing device 302 can include a processing resource 304 that can be utilized to execute instructions 334, 336, 338, 340, 342 stored on the memory resource 306.

The computing device 302 can include instructions 334 stored by the memory resource 306, that when executed by a processing resource 304 can identify a first receipt that overlaps a second receipt from the plurality of receipts within the scanned image. In some examples, the scanned image can be generated by the scanning device 346. As described herein, the scanned image can have a patterned background that can be identified by the computing device 302 to distinguish between the background and the plurality of receipts.

In some examples, identifying that a first receipt overlaps a second receipt can include identifying an irregular shape when compared to a shape of other receipts of the plurality of receipts. For example, the other receipts of the plurality of receipts can be substantially rectangular and the irregular shape can be substantially non-rectangular. For example, the non-rectangular shape can be a polygon shape that can be identified as a plurality of rectangular receipts that are overlapping. In some examples, the identified irregular shape can be separated from the other receipts of the plurality of receipts to perform other image operations (e.g., convolution, watershed, erosion, etc.).

The computing device 302 can include instructions 336 stored by the memory resource 306, that when executed by a processing resource 304 can generate a watershed image of the scanned image by subtracting a background image of the scanned image from a foreground image of the scanned image. In some examples, the computing device 302 can utilize the scanned image to generate a background image and a foreground image. In some examples, the background image can be a sure background image and the foreground image can be a sure foreground image. In these examples, the background image can be subtracted from the foreground image to generate a watershed image. In other examples, the watershed image can be generated by utilizing a watershed filter as described herein. In some examples, the watershed image can be utilized to highlight the outline or boundaries of the first receipt and the second receipt.

The computing device 302 can include instructions 338 stored by the memory resource 306, that when executed by a processing resource 304 can generate an eroded image of the watershed image by performing grayscale erosion on the watershed image. In some examples, the watershed image can be a grayscale image. As used herein, a grayscale image can include an image where a value of each pixel represents a quantity of light or represents intensity information. For example, the grayscale image can include black, white, or gray monochrome. That is, the grayscale image can include different shades of gray compared to different shades of color. As described herein, a grayscale erosion can remove pixels that include a relatively lower value within a particular area, which can further highlight the borders or outline of the first receipt and/or second receipt.

The computing device 302 can include instructions 340 stored by the memory resource 306, that when executed by a processing resource 304 can identify an outline of the first receipt and the second receipt based on a rectangle search within the eroded image. As described herein, a shape of a plurality of elements of a scanned image can be determined and a corresponding shape search can be performed on the eroded image to determine an outline shape of the plurality of elements. For example, the shape of a plurality of receipts can be substantially rectangular. In this example, a rectangle shape search can be performed on the eroded image to identify rectangular shaped elements within the eroded image. In some examples, the eroded image can include highlighted outlines of the first receipt and the second receipt such that the rectangle shape search can identify the outline of the first receipt and the second receipt. In some examples, the rectangle shape search can identify the outline of the first receipt, the outline of the second receipt, and/or an overlap portion where the first receipt overlaps the second receipt.

In some examples, the rectangle shape search can extrapolate the outline of the second receipt through an overlap portion where the first receipt covers the second receipt. For example, the overlap portion can be a portion where the first receipt covers the second receipt. In this example, the outline of the second receipt can be extrapolated through the first receipt to extend the outline of the second receipt through the overlap portion. In this way, a more precise area of the overlap portion can be identified, which can allow a more precise cropping of the overlap portion when separating the first receipt from the second receipt as described herein.

The computing device 302 can include instructions 342 stored by the memory resource 306, that when executed by a processing resource 304 can split the first receipt and the second receipt by cropping a portion of the first receipt that overlaps the second receipt. In some examples, the first receipt and the second receipt can be split along the outlines or borders of the first receipt and second receipt. For example, the first receipt can be extracted from the scanned image along the outline defined by the rectangle shape search. In this example, the second receipt can be extracted from the scanned image along the outline defined by the rectangle shape search and the overlap portion that includes a portion of the first receipt can be removed from the extracted second receipt.

In some examples, the extracted first receipt can be utilized to generate a first image and the extracted second receipt can be utilized to generate a second image that is separate from the first image. In some examples, the extracted first receipt and the extracted second receipt can be embedded within a single image such that a space exists between the previously overlapping receipts. In some examples, the computing device 302 can be utilized to alter an orientation of the first receipt and/or the second receipt. For example, the orientation of the first receipt and/or second receipt can be positioned at an angle due to the overlap as described herein. In this example, the orientation of the separated first receipt and separated second receipt can be alter to a closest predetermined angle (e.g., closest 90 degree angle, etc.). In some examples, computing device 302 can rotate the first image to a nearest square angle for the first receipt and to rotate the second image to a nearest square angle for the second receipt. As used herein, a nearest square angle can include a nearest 90 degree angle. In this way, the first receipt and the second receipt can be aligned in a particular orientation even though their respective original orientations may have been different due to overlapping.

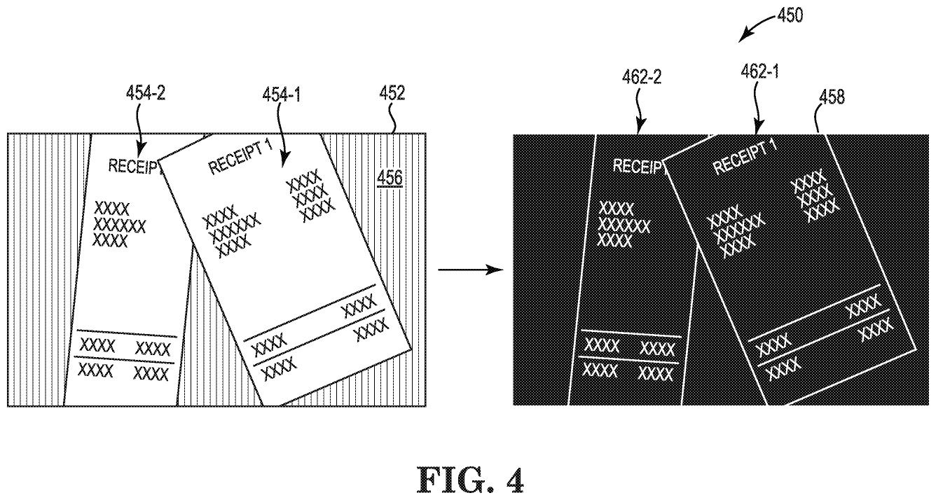

FIG. 4 is an example of images 450 when convolving an image consistent with the present disclosure. In some examples, the images 450 can be generated or implemented by a computing device. For example, the images 450 can illustrate an effect of a convolution filter on an image. In some examples, the images 450 can be illustrated through a first image 452 and a second image 458. In some examples, the first image 452 can be a scanned image that is generated by a scanning device (e.g., scanning device 346 as referenced in FIG. 3, etc.) and the second image 458 can be convolved image of the first image 452. As used herein, a convolved image can include an image where a convolution filter was applied. For example, the convolved second image 458 can be a result of applying a convolution filter on the scanned first image 452.

In some examples, the first image 452 can include a patterned background 456. As described herein, the patterned background 456 can be a uniformed pattern that is known to a computing device such that a plurality of elements can be more easily identified. For example, the patterned background 456 can include a plurality of lines that are spaced at a specific distance. In this way, a computing device can identify a plurality of elements when the pattern is interrupted by an element positioned on the patterned background 456.

In some examples, the first image 452 can include a first element 454-1 and a second element 454-2. In some examples, the first element 454-1 and the second element 454-2 can be identified as elements utilizing the patterned background 456. For example, the first element 454-1 and/or the second element 454-2 can interrupt the pattern of the patterned background 456, which can indicate that an element is covering the patterned background 456. In some examples, the first element 454-1 can be identified as overlapping a portion of the second element 454-2. As described herein, the first element 454-1 can be identified as overlapping the second element 454-2 when a shape of an identified element (e.g., combination of the first element 454-1 and the second element 454-2, etc.) is different than an expected shape of identified elements (e.g., substantially rectangular, etc.).

As described herein, the images 450 can illustrate an effect of applying a convolution filter to the first image 452 to generate the second image 458. In some examples, the convolution filter can generate a grayscale image that can highlight lines within the first image 452. For example, the second image 458 can be a grayscale image that includes the outlines of the first element 462-1 and/or the second element 462-2. In this example, the first element 462-1 in the second image 458 can correspond to the first image 454-1 in the first image 452 and the second element 462-2 in the second image 458 can correspond to the second image 454-2 in the first image 452. In some examples, the second image 458 can be utilized to determine borders of the plurality of elements.

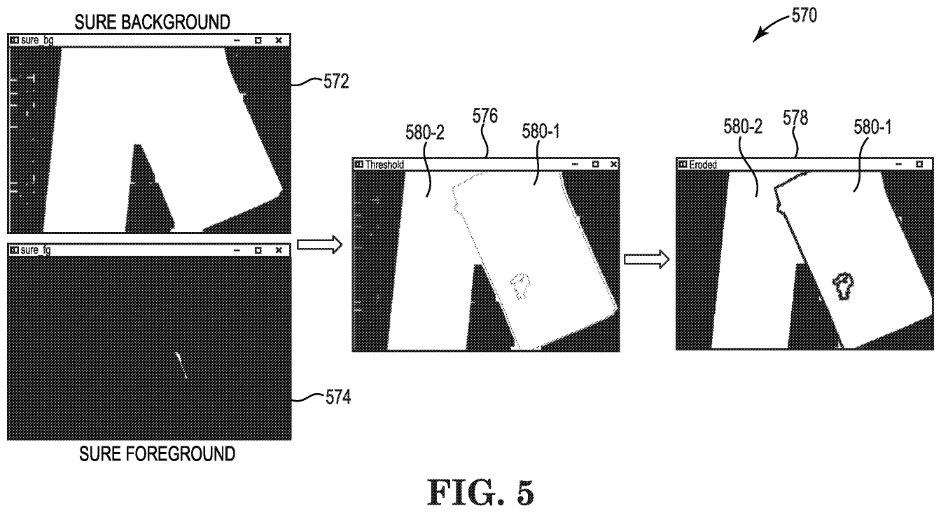

FIG. 5 is an example of images 570 when determining borders of elements within an image consistent with the present disclosure. In some examples, the convolved image (e.g., second image 458 as referenced in FIG. 4, etc.) can be utilized to generate a sure background image 572 and a sure foreground image 574. In some examples, the sure background image 572 and the sure foreground image 574 can be utilized to identify a threshold of the image. As used herein, a threshold of the image can include a maximum priority level and/or a minimum priority level for each pixel within the image.

In some examples, the sure background image 572 can be subtracted from the sure foreground image 574. In some examples, the subtracted image can be utilized to apply a watershed process to generate a watershed image 576. As described herein, the watershed process can prioritize pixels and highlight higher priority pixels over lower priority pixels. In this way, an outline of a first element 580-1 and an outline of a second element 580-1 can be highlighted or identified. In some examples, the watershed image 576 can be utilized to apply an erosion process to generate an eroded image 578.

In some examples, the erosion process can be utilized to remove lower priority pixels within a particular area of the image. For example, the outline of the first element 580-1 and/or the second element 580-2 can be a relatively high priority and pixels surrounding the outline can be removed to further highlight the outline and/or borders of the first element 580-1 and/or second element 580-2. In some examples, the eroded image 578 can be utilized to apply a shape search as described further herein.

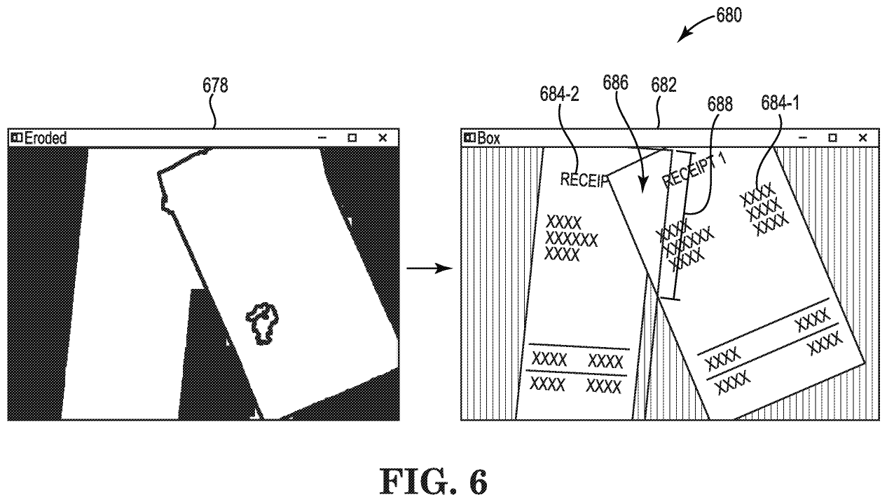

FIG. 6 is an example of images 680 when performing a shape search on an image consistent with the present disclosure. In some examples, the images 680 can include an eroded image 678 (e.g., eroded image 578 as referenced in FIG. 5, etc.) to identify an outline of a first element 684-1 and/or a second element 684-2. In some examples, a shape search, such a rectangle search, can be performed on the eroded image 678 to generate a shaped image 682 that can outline a border of the first element 684-1 and the second element 684-2.

In some examples, the shaped image 682 can identify an overlap portion 686. As described herein, the overlap portion 686 can be a portion of the second element 684-2 that is covered by the first element 684-1. In some examples, the shape search can be utilized to identify a particular shape of a plurality of elements. For example, the shape search can be a rectangle search to identify rectangular shaped elements within the image. In some examples, the shape search can extrapolate an outline or border of an element that is covered by a different element. For example, the shape search can extrapolate a border portion 688 of the second element 684-2 that is covered by the first element 684-1. In this way, a more accurate overlap portion 688 can be identified.

In some examples, the overlap portion 688 can be cropped from a separated second element 684-2 such that data associated with the first element 684-1 is not included with data associated with the second element 684-2. For example, the overlap portion 688 can include address information data that is printed on the first element 684-1. In some examples, the overlap portion 688 can be cropped from the second element 684-2 such that the address information data that is printed on the first element 684-1 is not included with data associated with the second element 684-2.

The above specification, examples and data provide a description of the method and applications and use of the system and method of the present disclosure. Since many examples can be made without departing from the spirit and scope of the system and method of the present disclosure, this specification merely sets forth some of the many possible example configurations and implementations.

What is claimed:

1. A computing device, comprising:
a processing resource;
a non-transitory computer readable medium storing instructions executable by the processing resource to:
identify when a first element overlaps a second element within a first image;
identify an overlap location based on a shape search within the first image to identify an outline of the first element and the second element; and
generate a second image that includes:
the first element without the second element; and
the second element with a cropped portion that corresponds to the overlap location.

2. The computing device of claim 1, comprising instructions executable by the processing resource to:
generate a foreground image and a background image of the first image;
subtract the foreground image from the background image to generate a watershed image; and
perform a plurality of erosion processes on the watershed image to identify a portion of a border of the first element.

3. The computing device of claim 2, wherein the portion of the border of the first element corresponds to the overlap location.

4. The computing device of claim 1, comprising instructions executable by the processing resource to rotate the first element and the second element based on an orientation of images on the first element and second element respectively.

5. The computing device of claim 1, wherein the shape search corresponds to a determined shape of the first element and the second element from the first image.

6. The computing device of claim 1, wherein the second image is split into a third image that includes the first element and a fourth image that includes the second element with the cropped portion that corresponds to the overlap location.

7. A non-transitory computer-readable storage medium comprising instructions when executed cause a processor of a computing device to:
identify a plurality of rectangular elements within a first image;
identify a first rectangular element that overlaps a second rectangular element from the plurality of rectangular elements within the first image;
utilize a first filter to generate a watershed image of the first image;
utilize a second filter to generate an eroded image of the watershed image;
identify an outline of the first rectangular element and the second rectangular element based on a rectangle search within the eroded image; and
split the first rectangular element and the second rectangular element based on the outline of the first rectangular element and the second rectangular element.

8. The medium of claim 7, wherein the first image includes a patterned background that corresponds to the first filter.

9. The medium of claim 7, comprising instructions to cause the processor of the computing device to generate a second image that includes only the first image and a third image that includes only the second image.

10. The medium of claim 9, comprising instructions to cause the processor of the computing device to convert the second image and the third image into a same format as the first image.

11. The medium of claim 7, comprising instructions to cause the processor of the computing device to identify an overlap portion of the second rectangular element based on the outline of the first rectangular element and the second rectangular element.

12. The medium of claim 11, comprising instructions to cause the processor of the computing device to remove the overlap portion of the second rectangular element.

13. A system, comprising:
a scanning device to capture a scanned image of a plurality of receipts positioned on a patterned background; and
a computing device, comprising instructions to:
identify a first receipt that overlaps a second receipt from the plurality of receipts within the scanned image;
generate a watershed image of the scanned image by subtracting a background image of the scanned image from a foreground image of the scanned image;
generate an eroded image of the watershed image by performing grayscale erosion on the watershed image;
identify an outline of the first receipt and the second receipt based on a rectangle search within the eroded image; and
split the first receipt and the second receipt by cropping a portion of the first receipt that overlaps the second receipt.

14. The system of claim 13, wherein the instructions to split the first receipt and the second receipt includes generated a first image of the first receipt and generating a second image of the second receipt with the cropped portion from the first receipt.

15. The system of claim 14, comprising instructions to rotate the first image to a nearest square angle for the first receipt and to rotate the second image to a nearest square angle for the second receipt.
